(19) United States
(12) Patent Application Publication
(10) Pub. No.: US 2024/0219169 A1
(43) Pub. Date: Jul. 4, 2024

(54) THICKNESS DETECTING DEVICE AND THICKNESS DETECTING METHOD

(71) Applicant: AAC Microtech (Changzhou) Co., Ltd., Changzhou (CN)

(72) Inventors: Yiren Cao, Changzhou (CN); Chongdeng Wu, Changzhou (CN); Xueyuan Zhu, Changzhou (CN)

(21) Appl. No.: 18/335,952

(22) Filed: Jun. 15, 2023

Related U.S. Application Data
(63) Continuation of application No. PCT/CN2023/074370, filed on Feb. 3, 2023.

(30) Foreign Application Priority Data
Dec. 29, 2022 (CN) 202211713655.4

(51) Int. Cl. G01B 11/06; G06T 7/521

(52) U.S. Cl. CPC G01B 11/06; G06T 7/521

(57) ABSTRACT

A thickness detecting device and a thickness detecting method are provided. The thickness detecting device includes: a mounting base provided with first and second mounting grooves; an image acquisition device movably mounted in the first mounting groove; and a light source movably mounted in the second mounting groove. The first and second mounting grooves extend along first and second directions, respectively. A preset angle is formed between a shooting direction of the image acquisition device and the second direction, the preset angle increases and decreases as the image acquisition device moves along the first direction. The light source can move along the second direction to be adjacent to or far away from a workpiece to be detected. By adopting the light source and image acquisition device that are separated, it is unnecessary to scan during the thickness detection, thereby shortening the detection time and improving the detection efficiency.

### TECHNICAL FIELD

The present disclosure relates to a technical field of a thickness detecting device and, in particular, to a thickness detecting device and a thickness detecting method.

### BACKGROUND

In the related art, a laser device and a camera are mounted in one piece to detect a thickness of a product. The laser device emits a line laser perpendicular to the product and for scanning. The camera is inclined to shoot the product irradiated by laser to obtain point cloud data. After scanning is completed, the point cloud data of the thickness measuring area is calculated to obtain a thickness measurement result.

The existing structure and methods for thickness detection have following defects:

1. Laser scanning takes a long time and detection efficiency is low.

2. The integrated structure of the laser device and the camera has narrow range of application. Upon detecting different products, if the camera, lens or laser is not applicable, the apparatus is required to be replaced.

### SUMMARY

The present disclosure aims to provide a thickness detecting device and a thickness detecting method in order to solve the technical problems in the related art.

A first aspect of the present disclosure provides a thickness detecting device. The thickness detecting device includes: a mounting base provided with a first mounting groove and a second mounting groove, the first mounting groove extends along a first direction, the second mounting groove extends along a second direction; an image acquisition device movably mounted in the first mounting groove, a preset angle is formed between a shooting direction of the image acquisition device and the second direction, and the preset angle increases and decreases as the image acquisition device moves along the first direction; and a light source movably mounted in the second mounting groove, the light source is movable along the second direction to be adjacent to or far away from a workpiece to be detected.

As an improvement, the first mounting groove is an arc groove, and the first direction is an extending direction of the arc groove.

As an improvement, two first mounting groove are provided in parallel to each other.

As an improvement, the second mounting groove is a strip-shaped groove extending along a direction of gravity, and the second direction is an extending direction of the strip-shaped groove.

As an improvement, the image acquisition device is disposed on the first fixation base, a first fixation hole is provided on a surface of the first fixation base, the first fixation hole corresponds to the first mounting groove, so that a bolt forms thread fitting with the first fixation hole after passing through the first mounting groove.

As an improvement, the light source is disposed on a second fixation base, a second fixation hole is provided on a surface of the second fixation base, the second fixation hole corresponds to the second mounting groove, so that a bolt forms thread fitting with the second fixation hole after passing through the second mounting groove.

As an improvement, the image acquisition device comprises a camera or a video camera.

A second aspect of the present disclosure provides a thickness detecting method. The thickness detecting method includes following steps: S100: disposing the workpiece to be detected directly below the light source; S101: changing the shooting direction of the image acquisition device by adjusting the position of the image acquisition device in the first mounting groove; S102: changing the height of the light source by adjusting the position of the light source in the second mounting groove; and S103: irradiating by the light source on the surface of the workpiece to be detected and the reference surface with a known height to form light spots, the light spots are located within the shooting range of the image acquisition device, the image acquisition device captures the images of the light spots, and the thickness of the workpiece to be detected is calculated according to the positions of the light spots on the surface of the workpiece to be detected and the reference light spot on the reference surface.

A third aspect of the present disclosure provides a thickness detecting device. The thickness detecting device includes: a mounting base provided with a first mounting groove and a second mounting groove, the first mounting groove extends along a first direction, the second mounting groove extends along the second direction; a light source movably mounted in the first mounting groove, a preset angle is formed between an irradiating direction of the light emitted by the light source and the second direction, the preset angle increases and decreases as the light source moves along the first direction; and an image acquisition device movably mounted in the second mounting groove, the image acquisition device is movable along the second direction to be adjacent to or far away from a workpiece to be detected.

A fourth aspect of the present disclosure provides a thickness detecting method. The thickness detecting method includes following steps: S100: disposing the workpiece to be detected directly below the image acquisition device; S101: changing an irradiating direction of the light emitted by the light source by adjusting the position of the light source in the first mounting groove; S102: changing the height of the image acquisition device by adjusting the position of the image acquisition device in the second mounting groove; and S103: irradiating by the light source on the surface of the workpiece to be detected and the reference surface with a known height to form light spots, the light spots are located within the shooting range of the image acquisition device, the image acquisition device captures the images of the light spots, and the thickness of the workpiece to be detected is calculated according to the positions of the light spots on the surface of the workpiece to be detected and the reference light spot on the reference surface.

Compared with the related art, the present disclosure is convenient for device adjustment and reuse by adopting the light source and image acquisition device that are separated from each other. The light source irradiates to the surface of the workpiece to be detected and the reference surface with known height to form light spots. The image of the light spots is collected by the image acquisition device. The thickness of the workpiece to be detected is calculated according to the location of the light spots on the surface of the workpiece to be detected and the reference surface in the image. Thus, no scanning is required during thickness detection, which shortens the detection time and improves the detection efficiency.

### BRIEF DESCRIPTION OF DRAWINGS

FIG. 1 is a perspective view of an overall structure according to Embodiment 1 of the present disclosure;

FIG. 2 is a structural diagram of a mounting base according to Embodiment 1 of the present disclosure;

FIG. 3 is a first perspective view of a first fixation base according to Embodiment 1 of the present disclosure;

FIG. 4 is a second perspective view of a first fixation base according to Embodiment 1 of the present disclosure;

FIG. 5 is a first perspective view of a second fixation base according to Embodiment 1 of the present disclosure;

FIG. 6 is a second perspective view of a second fixation base according to Embodiment 1 of the present disclosure; and

FIG. 7 is a perspective view of an overall structure according to Embodiment 2 of the present disclosure.

### REFERENCE SIGNS

10—Mounting base, 11—First mounting groove, 12—Second mounting groove, 13—Bottom plate, 14—Side plate, 15—Reinforcing plate, 16—Third mounting groove, 17—Weight reduction hole;
20—Image acquisition device;
30—Light source;
40—First fixation base, 41—First fixation hole, 42—Fourth mounting groove;
50—Second fixation base, 51—Second fixation hole, 52—Fixation groove, 53—Opening;
60—Workpiece to be tested.

### DESCRIPTION OF EMBODIMENTS

The Embodiments described with reference to the accompanying drawings are exemplary, which is only used to explain the present disclosure, and cannot be construed as limiting the present disclosure.

### Embodiment 1

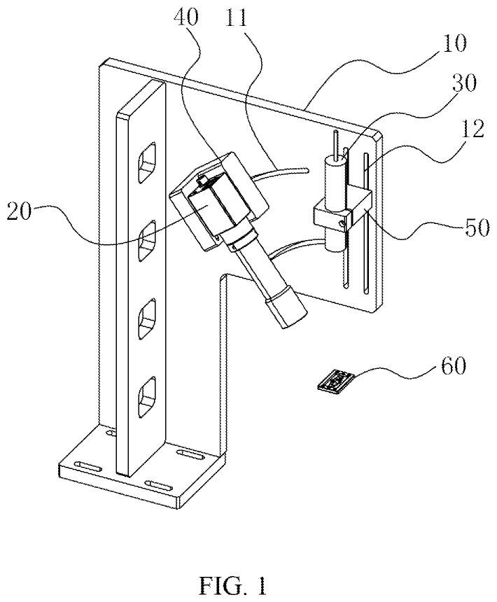

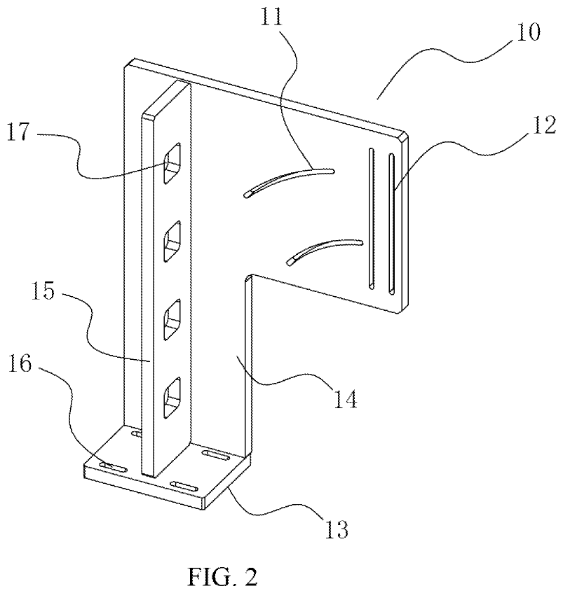

Referring to FIG. 1 and FIG. 2, this embodiment provides a thickness detecting device, which includes a mounting base 10, an image acquisition device 20 and a light source 30.

A first mounting groove 11 and a second mounting groove 12 are provided on the mounting base 10. The first mounting groove 11 extends along a first direction, and the second mounting groove 12 extends along a second direction.

The image acquisition device 20 is movably mounted on the first mounting groove 11. A preset angle is formed between a shooting direction of the image acquisition device 20 and the second direction. The preset angle increases or decreases with the movement of the image acquisition device 20 along the first direction. Therefore, by adjusting different mounting positions of the image acquisition device 20 in the first mounting groove 11, the shooting direction of the image acquisition device 20 can be changed to adapt the detection requirements of different types and structures of the workpiece to be detected 60.

The light source 30 can be movably mounted on the second mounting groove 12. The light source 30 can move along the second direction to be adjacent to or far away from the workpiece to be detected 60. By adjusting the position of the light source 30 fixed on the second mounting groove 12, an operating distance between the light source 30 and the workpiece to be detected 60 is changed to adapt the detection requirements of different types and structures of the workpiece to be detected 60.

Based on the above embodiment, the operating process of the present disclosure is as follows.

A standard reference object (not shown) is determined. The standard reference object has a reference surface with a known height. After adjusting the positions of the image acquisition device 20 and the light source 30, the light source 30 irradiates to the surface of the workpiece to be detected 60 to form a real-time light spot, and irradiates to a reference surface to form a reference light spot. According to the positions of the real-time light spot and the reference light spot, the thickness of the workpiece to be detected 60 is calculated.

By using the image acquisition device 20 and light source 30 that are separated from each other, it is convenient for the device adjustment and reuse of the thickness detecting device, and there is no need to conduct scanning during the thickness detection, which shortens the detection time and improves the detection efficiency.

Further, a light irradiating direction of the light source 30 is perpendicular to a plane where the workpiece to be detected 60 is located. The workpiece to be detected 60 is disposed on a support surface extending horizontally. The workpiece to be detected 60 is located directly below the light source 30. The light spot position is fixed. A person skilled in the art can understand that, a certain angle can be formed between the irradiating direction of light emitted by the light source 30 and the plane where the workpiece to be detected 60 is located, so as to obtain the real-time light spot at multiple surfaces, which is not limited here.

In some embodiments provided in the present disclosure, as shown in FIG. 2, the mounting base 10 is composed of a bottom plate 13, a side plate 14 and a reinforcing plate 15. The bottom plate 13 is provided with multiple third mounting grooves 16. The bottom plate 13 is fixed on an operating surface through the cooperation of a bolt and the third mounting groove 16. In order to facilitate the adjustment of the fixed position of the mounting base 10, the third mounting groove 16 is a waist-shaped structure, so that the mounting base 10 is fixed in an appropriate position to adapt to the workpiece to be detected 60 transferred from conveying parts such as a flow channel or a turntable. The side plate 14 is fixed on the bottom plate 13. The bottom surface of the reinforcing plate 15 is connected to the bottom plate 13. A side surface of the reinforcing plate 15 is connected to the side plate 14, so as to improve the overall strength of the mounting base 10 and avoid inclination of the side plate 14. The first mounting groove 11 and the second mounting groove 12 are disposed on the side plate 14. The reinforcing plate 15 is also provided with multiple weight reduction holes 17. The weight reduction hole 17 is configured to reduce the overall weight and for efficient wiring, to avoid complex wiring layout.

In some embodiments, referring to FIG. 1 and FIG. 2, the first mounting groove 11 is an arc groove. The first direction is an extending direction of the arc groove. The first mounting groove 11 is located obliquely above the slope of the workpiece to be detected 60. The first direction is a direction of an arc curve. By moving the position of the image acquisition device 20 in the first mounting groove 11, the angle of the shooting direction of the image acquisition device 20 can be adjusted to obtain information of the real-time light spot of multiple surfaces, so as to adapt the detection requirements of different types and structures of the workpiece to be detected 60. The person skilled in the art can know that the first mounting groove 11 can also have other structures, as long as the shooting angle of the image acquisition device 20 can be changed, which is not limited here.

Further, according to the type of the workpiece to be detected 60 and the measurement requirements, one or more image acquisition devices 20 can be provided. Each image acquisition device 20 shall be provided with one corresponding first mounting groove 11 to fix the position and adjust the angle. When there are two image acquisition devices 20, two first mounting grooves 11 are provided. The two first mounting grooves 11 are parallel to each other. One image acquisition device 20 is disposed in each first mounting groove 11. The shooting angle of each image acquisition device 20 can be adjusted independently, so that the real-time light spot information of multiple positions of the workpiece to be detected 60 can be obtained. Thus, the thickness value of multiple positions can be calculated, and the obtained multiple thickness values can be averaged to obtain an averaged thickness, in order to improve the detection accuracy.

In some embodiments, referring to FIG. 1 and FIG. 2, the second mounting groove 12 is a strip-shaped groove extending along a direction of gravity. The second direction is the extending direction of the strip-shaped groove. The second mounting groove 12 is located directly above the workpiece to be detected 60. By moving the position of the light source 30 in the second mounting groove 12, the distance between the light source 30 and the workpiece to be detected 60 can be adjusted to adapt the detection requirements of different types and structures of the workpiece to be detected 60. The person skilled in the art can understand that the second mounting groove 12 can also have other structures, as long as the height of the light source 30 can be changed, which is not limited here.

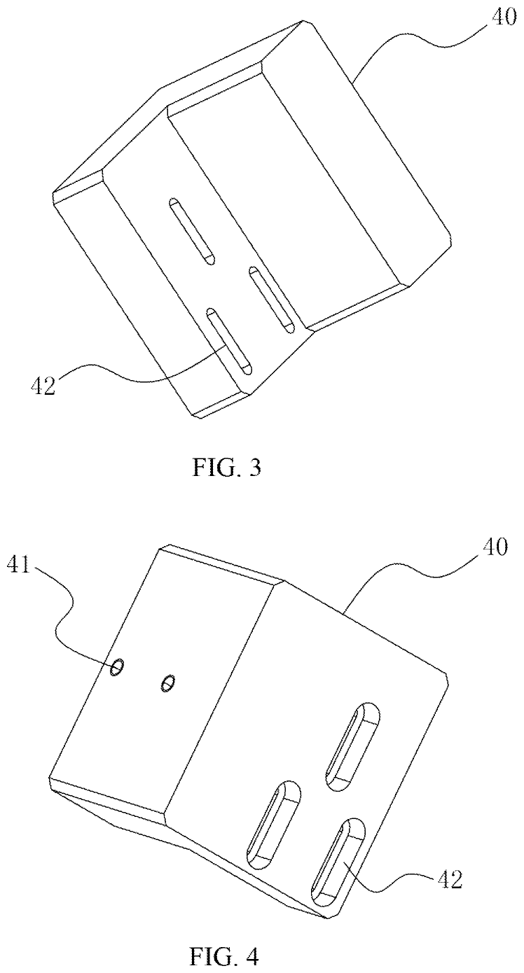

In some embodiments, referring to FIG. 3 and FIG. 4, the image acquisition device 20 is disposed on the first fixation base 40. A first fixation hole 41 is provided on the surface of the first fixation base 40. The first fixation hole 41 corresponds to the first mounting groove 11, so that the bolt can form thread fitting with the first fixation hole 41 after passing through the first mounting groove 11. When it is necessary to adjust the position of the first fixation base 40, the bolt is unscrewed. When the first fixation base 40 reaches a preset position, the bolt is tightened, which is convenient for operation.

In some embodiments, referring to FIG. 3 and FIG. 4, the first fixation base 40 is an “L” shaped block. The first fixation hole 41 is disposed on a horizontal plate section of the first fixation base 40. A vertical plate section of the first fixation base 40 is provided with multiple fourth mounting grooves 42. The image acquisition device 20 is assembled in the fourth mounting groove 42 through a bolt. The fourth mounting groove 42 has a waist-shaped structure to facilitate the adjustment of the fixed position of the image acquisition device 20 and to finely tune the distance between the image acquisition device 20 and the workpiece to be detected 60.

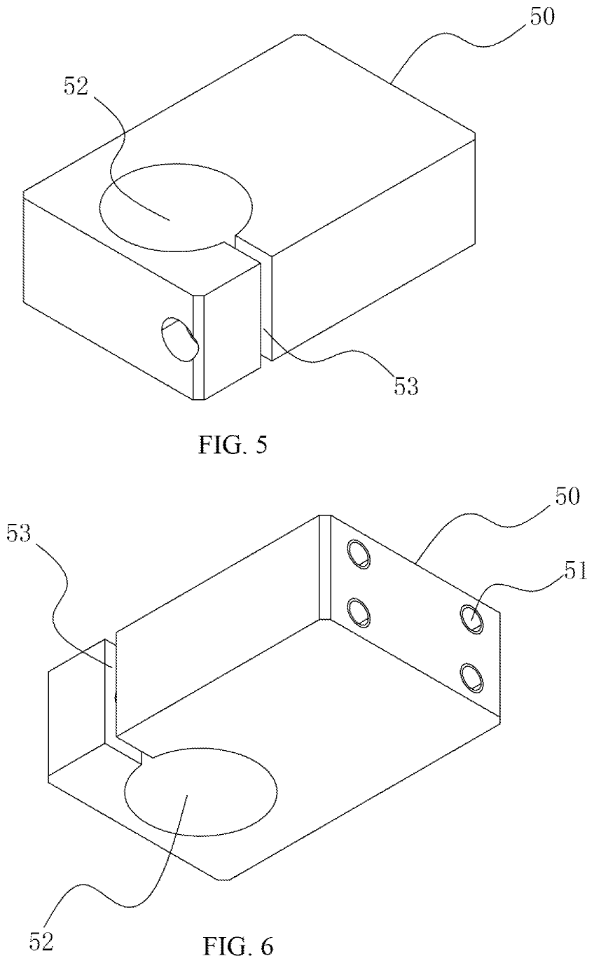

In some embodiments, referring to FIG. 5 and FIG. 6, the light source 30 is disposed on the second mounting base 50. A second fixation hole 51 is provided on the surface of the second fixation base 50. The second fixation hole 51 corresponds to the second mounting groove 12, so that the bolt can form thread fitting with the second fixation hole 51 after passing through the second mounting groove 12. When it is necessary to adjust the position of the second fixation base 50, the bolt is unscrewed. When the second fixation base 50 reaches a preset position, the bolt is tightened, which is convenient for operation.

In some embodiments, referring to FIG. 5 and FIG. 6, the second fixation base 50 is provided with a fixation groove 52. The light source 30 passes through the fixation groove 52. The fixation groove 52 forms an opening 53 on the second fixation base 50. A bolt passes through the opening 53. The light source 30 is clamped or released by tightening or unscrewing the bolt, which is convenient for operation. By adjusting the mounting position of the light source 30 in the fixation groove 52, the height position of the light source 30 can also be finely tuned.

In some embodiments, the image acquisition device 20 includes a camera or a video camera, so as to obtain an image including light spots. The image acquisition device 20 can continuously shooting to form a video image, or can collect images at a certain time interval, which is not limited here.

In some embodiments, the light source 30 includes a laser source. The light emitted by the laser source 30 has directional light-emitting characteristics, small divergence, good focusing effect, high brightness, high resolution and easy identification, thereby providing favorable conditions for subsequent thickness detection. The person skilled in the art can understand that the light source 30 can also be of other types, e.g., focusing halide lamp, focusing xenon lamp, focusing incandescent lamp or any other light source 30 which can form real-time light spot on the surface of the workpiece to be detected 60, which is not limited here.

Based on the above embodiments, the present disclosure further provides a thickness detecting method, which adopts the thickness detecting device for thickness detection. The thickness detecting method includes following steps.

S100: The workpiece to be detected 60 is disposed directly below the light source 30.

S101: By adjusting the position of the image acquisition device 20 fixed on the first mounting groove 11, the shooting direction of the image acquisition device 20 is changed, and the position of the image acquisition device 20 is determined according to the detection requirements of the workpiece to be detected 60 of different types and structures.

S102: By adjusting the position of the light source 30 fixed on the second mounting groove 12, the height of the light source 30 is changed, and the position of the light source 30 is determined according to the detection requirements of the workpiece to be detected 60 of different types and structures.

S103: A standard reference object is determined. The standard reference object has a reference surface with a known height. The light source 30 irradiates on the surface of the workpiece to be detected 60 and the reference surface with a known height to form light spots. The light spots are located within the shooting range of the image acquisition device 20. The image acquisition device 20 captures the image of the light spot. The thickness of the workpiece to be detected 60 is calculated according to the positions of the light spots on the surface of the workpiece to be detected 60 and the reference light spot on the reference surface.

### Embodiment 2

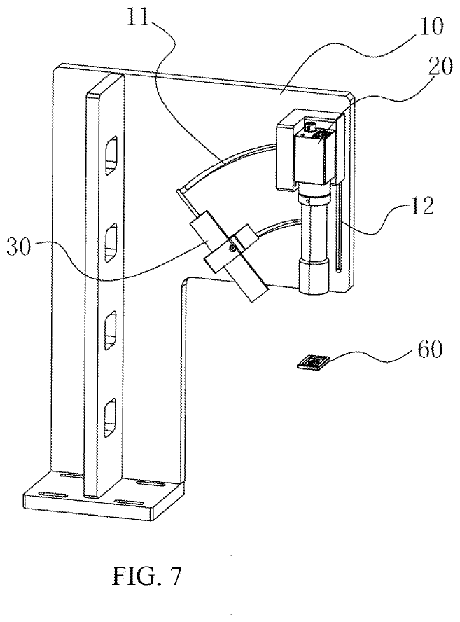

Referring to FIG. 7, a thickness detecting device is provided, which includes a mounting base 10, an image acquisition device 20 and a light source 30.

A first mounting groove 11 and a second mounting groove 12 are disposed on the mounting base 10. The first mounting groove 11 extends along a first direction, and the second mounting groove 12 extends along a second direction.

The light source 30 is movably mounted on the first mounting groove 11. A preset angle is formed between an irradiating direction of the light emitted by the light source 30 and the second direction. The preset angle increases or decreases with the movement of the light source 30 along the first direction. Therefore, by adjusting different mounting positions of the light source 30 on the first mounting groove 11, the irradiating direction of the light emitted by the light source 30 can be changed to adapt the detection requirements of different types and structures of the workpiece to be detected 60.

The image acquisition device 20 can be movably mounted in the second mounting groove 12. The image acquisition device 20 can move along the second direction to be adjacent to or far away from the workpiece to be detected 60. By adjusting the position of the image acquisition device 20 fixed on the second mounting groove 12, an operating distance between the image acquisition device 20 and the workpiece to be detected 60 is changed to adapt the detection requirements of different types and structures of the workpiece to be detected 60.

Based on the above embodiment, the operating process of the present disclosure is as follows.

A standard reference object (not shown) is determined. The standard reference object has a reference surface with a known height. After adjusting the positions of the light source 30 and the image acquisition device 20, the light source 30 irradiates to the surface of the workpiece to be detected 60 to form a real-time light spot, and irradiates to a reference surface to form a reference light spot. According to the positions of the real-time light spot and the reference light spot, the thickness of the workpiece to be detected 60 is calculated.

By using the light source 30 and the image acquisition device 20 that are separated from each other, it is convenient for the device adjustment and reuse of the thickness detecting device, and there is no need to perform scanning during the thickness detection, which shortens the detection time and improves the detection efficiency.

Further, a shooting direction of the image acquisition device 20 is perpendicular to a plane where the workpiece to be detected 60 is located. The workpiece to be detected 60 is disposed on a support surface extending horizontally. The workpiece to be detected 60 is located directly below image acquisition device 20, and the center of visual field is fixed. The image acquisition device 20 collects the real-time light spot on the top surface of the workpiece to be detected 60 without interference of the real-time light spots on other surfaces of the workpiece to be detected 60, so as to calculate and analyze the pattern of real-time light spots collected. A person skilled in the art can understand that, a certain angle can be formed between shooting direction of the image acquisition device 20 and the plane where the workpiece to be detected 60 is located, so as to obtain information of the real-time light spots at multiple surfaces, which is not limited here.

In some embodiments, the first mounting groove 11 is an arc groove. The first direction is an extending direction of the arc groove. The first mounting groove 11 is located obliquely above the slope of the workpiece to be detected 60. The first direction is a direction of an arc curve. By moving the position of the light source 30 in the first mounting groove 11, the irradiating angle of light emitted by the light source 30 can be adjusted, the positions of the light spots on the workpiece to be detected 60 are also changed accordingly, so as to adapt the detection requirements of different types and structures of the workpiece to be detected 60. The person skilled in the art can know that the first mounting groove 11 can also has other structures, as long as the light angle of the light source 30 can be changed, which is not limited here.

Further, according to the type of the workpiece to be detected 60 and the measurement requirements, one or more light sources 30 can be provided. Each light source 30 shall be provided with one corresponding first mounting groove 11 to fix the position and adjust the angle. When there are two light sources 30, two first mounting grooves 11 are provided. The two first mounting grooves 11 are parallel to each other. One light source 30 is disposed on each first mounting groove 11. The light angle of each light source 30 can be adjusted independently, so that the real-time light spots of multiple positions of the workpiece to be detected 60 can be obtained. Thus, the thickness value of multiple positions can be calculated, and the obtained multiple thickness values can be averaged to obtain an averaged thickness, in order to improve the detection accuracy.

In some embodiments, the second mounting groove 12 is a strip-shaped groove extending along a direction of gravity. The second direction is the extending direction of the strip-shaped groove. The second mounting groove 12 is located directly above the workpiece to be detected 60. By moving the position of the image acquisition device 20 in the second mounting groove 12, the distance between the image acquisition device 20 and the workpiece to be detected 60 can be adjusted to adapt the detection requirements of different types and structures of the workpiece to be detected 60. The person skilled in the art can understand that the second mounting groove 12 can also has other structures, as long as the height of the image acquisition device 20 can be changed, which is not limited here.

Based on the above embodiments, the present disclosure further provides a thickness detecting method, which adopts the thickness detecting device for thickness detection. The thickness detecting method includes following steps.

S100: The workpiece to be detected 60 is disposed directly below the image acquisition device 20.

S101: By adjusting the position of the light source 30 fixed on the first mounting groove 11, the irradiating direction of the light emitted by the light source 30 is changed, and the position of the light source 30 is determined according to the detection requirements of the workpiece to be detected 60 of different types and structures.

S102: By adjusting the position of the image acquisition device 20 fixed on the second mounting groove 12, the height of the image acquisition device 20 is changed, and the position of the image acquisition device 20 is determined according to the detection requirements of the workpiece to be detected 60 of different types and structures.

S103: A standard reference object is determined. The standard reference object has a reference surface with a known height. The light source 30 irradiates on the surface of the workpiece to be detected 60 and the reference surface with a known height to form light spots. The light spots are located within the shooting range of the image acquisition device 20. The image acquisition device 20 captures the image of the light spot. The thickness of the workpiece to be detected 60 is calculated according to the positions of the light spots on the surface of the workpiece to be detected 60 and the reference light spot on the reference surface.

The structure, characteristics and effect of the present disclosure are explained in detail by the above embodiments shown by the accompany drawings. The above are only preferred embodiments of the present disclosure, but the present disclosure does not limit the scope of implementation by the drawings. The equivalent embodiments changed or modified according to the conception of the present disclosure without departing from the inventive concept of the present disclosure falls within the protection scope of the present disclosure.

What is claimed is:

1. A thickness detecting device, comprising:
a mounting base provided with a first mounting groove and a second mounting groove, wherein the first mounting groove extends along a first direction, the second mounting groove extends along a second direction;
an image acquisition device movably mounted in the first mounting groove, wherein a preset angle is formed between a shooting direction of the image acquisition device and the second direction, and the preset angle increases and decreases as the image acquisition device moves along the first direction; and
a light source movably mounted in the second mounting groove, wherein the light source is movable along the second direction to be adjacent to or far away from a workpiece to be detected.

2. The thickness detecting device as described in claim 1, wherein the first mounting groove is an arc groove, and the first direction is an extending direction of the arc groove.

3. The thickness detecting device as described in claim 1, wherein two first mounting grooves are provided in parallel to each other.

4. The thickness detecting device as described in claim 1, wherein the second mounting groove is a strip-shaped groove extending along a direction of gravity, and the second direction is an extending direction of the strip-shaped groove.

5. The thickness detecting device as described in claim 1, wherein the image acquisition device is disposed on the first fixation base, a first fixation hole is provided on a surface of the first fixation base, the first fixation hole corresponds to the first mounting groove, so that a bolt forms thread fitting with the first fixation hole after passing through the first mounting groove.

6. The thickness detecting device as described in claim 1, wherein the light source is disposed on a second fixation base, a second fixation hole is provided on a surface of the second fixation base, the second fixation hole corresponds to the second mounting groove, so that a bolt forms thread fitting with the second fixation hole after passing through the second mounting groove.

7. The thickness detecting device as described in claim 1, wherein the image acquisition device comprises a camera or a video camera.

8. A thickness detecting method, wherein thickness detection is performed by a thickness detecting device as described in claim 1, the method comprising following steps:
S100: disposing the workpiece to be detected directly below the light source;
S101: changing the shooting direction of the image acquisition device by adjusting the position of the image acquisition device in the first mounting groove;
S102: changing the height of the light source by adjusting the position of the light source in the second mounting groove; and
S103: irradiating by the light source on the surface of the workpiece to be detected and the reference surface with a known height to form light spots, wherein the light spots are located within the shooting range of the image acquisition device, the image acquisition device captures the images of the light spots, and the thickness of the workpiece to be detected is calculated according to the positions of the light spots on the surface of the workpiece to be detected and the reference light spot on the reference surface.

9. A thickness detecting device, comprising:
a mounting base provided with a first mounting groove and a second mounting groove, wherein the first mounting groove extends along a first direction, the second mounting groove extends along the second direction;
a light source movably mounted in the first mounting groove, wherein a preset angle is formed between an irradiating direction of the light emitted by the light source and the second direction, the preset angle increases and decreases as the light source moves along the first direction; and
an image acquisition device movably mounted in the second mounting groove, wherein the image acquisition device is movable along the second direction to be adjacent to or far away from a workpiece to be detected.
